(19) United States
(12) Patent Application Publication
(10) Pub. No.: US 2025/0386369 A1
(43) Pub. Date: Dec. 18, 2025

(54) RESOURCE ALLOCATION MECHANISMS FOR UNLICENSED SIDELINK COMMUNICATIONS

(71) Applicant: Parsa Wireless Communications LLC, Stamford, CT (US)

(72) Inventor: Reza Kalbasi, San Diego, CA (US)

(73) Assignee: Parsa Wireless Communications LLC, Stamford, CT (US)

(21) Appl. No.: 19/142,000

(22) PCT Filed: Jan. 5, 2024
(86) PCT No.: PCT/US2024/010417

§ 371 Date: Jun. 20, 2025

Related U.S. Application Data
(60) Provisional application No. 63/437,412, filed on Jan. 6, 2023.

(51) Int. Cl. H04W 74/0808; H04W 72/542

(52) U.S. Cl. CPC H04W 74/0808; H04W 72/542

(57) ABSTRACT

A method of wireless communication includes triggering, by a base station equipment, a listen-before-talk (LBT) process to determine one or more resources for transmission of data between a first user equipment (UE) and a second UE. The method includes transmitting to the second UE, via the first UE, the determined one or more resources and then receiving from the second UE, via the first UE, data information.

This application claims priority under 35 USC § 119(e) from U.S. Provisional Patent Application No. 63/437,412, filed on Jan. 6, 2023, (“the provisional application”); the content of the provisional patent application is incorporated herein by reference.

### BACKGROUND OF THE INVENTION

The present invention is directed to 5G, which is the 5th generation mobile network. It is a new global wireless standard after 1G, 2G, 3G, and 4G networks. 5G enables networks designed to connect machines, objects and devices.

The invention is more specifically directed to systems and/or methods transmitting to a second user equipment (UE), via a first UE, one or more determined resources and then receiving from the second UE, via the first UE, data information.

In an embodiment, the invention provides a method of wireless communication that includes triggering, by a base station equipment, a listen-before-talk (LBT) process to determine one or more resources for transmission of data between a first user equipment (UE) and a second UE. In the method, the first UE transmits to the second UE, the determined one or more resources and then the second UE receives, via the first UE, data information. The method can include triggering, by the second user equipment (UE), a listen-before-talk (LBT) process to determine a subset of the determined one or more resources for the transmission of data between the first UE and the second UE.

One or more resources may include multiple time slots and frequency subbands in unlicensed (UL) frequency spectrum. The second user equipment (UE) can reserve a subset of the determined one or more resources via sidelink control information (SCI) channel. The method can include transmitting, by the second user equipment (UE), to the base station (BS) via the first UE, a report including success or failure of the listen-before-talk (LBT) process. For that matter, the method may include performing, by the second user equipment (UE), a channel sensing process to measure the interference power in the available resources and determining whether the determined one or more resources are limited by any interference for the transmission of data.

In an embodiment, the invention provides a method of wireless communication that includes receiving, at a base station (BS), from a first user equipment (UE) via a second UE, a report including success or failure of one or more listen-before-talk (LBT) processes performed by the first UE; determining resources for the transmission of data between the first UE and the second UE based on the report; scheduling the first UE with the determined resources via the second UE; and receiving, the data from the first UE via the second UE in the scheduled resources. The determining can include determining resources associated to one or more successful LBT processes. The determined resources can include time slots and frequency subbands in unlicensed (UL) frequency spectrum.

In an embodiment, the invention provides a method of wireless communication, including receiving, from a base station (BS), at a first user equipment (UE) via a second UE, a message including one or more resources for the transmission of data between the first UE and the second UE; triggering, by the first UE, one or more listen-before-talk (LBT) processes to determine a subset of the one or more resources for the transmission of data between the first UE and the second UE; and transmitting data, to the BS via the second UE, in the subset of the one or more resources. The method can include transmitting, by the first user equipment (UE), to the base station (BS) via the second UE, a report including success or failure of the one or more listen-before-talk (LBT) processes. Alternatively, the method can include receiving, from the base station (BS), a message indicating one or more updated resources for the transmission of data between the first user equipment (UE) and the second UE, wherein: the one or more updated resources are determined to exclude resources with failed listen-before-talk (LBT) processes.

The one or more resources can include one or more time slots and frequency subbands in unlicensed (UL) frequency spectrum. The first user equipment (UE) can transmit the report to the second UE via a sidelink control information (SCI) channel. The first user equipment (UE) may reserve resources in the subset of the one or more resources via sidelink control information (SCI) channel. The user equipment (UE) may perform a channel sensing process to measure interference power in the one or more resources and determines whether any of the one or more resources are limited by any interference for the transmission of data.

In an embodiment, the invention provides a first user equipment (UE) have a transceiver configured to: receive a message from a base station via a second UE, the message including one or more resources for transmission of data between the first UE and the second UE; trigger a listen-before-talk (LBT) process to select a subset of the one or more resources for the transmission of data between the first UE and the second UE; in response to the LBT, determine the subset of the one or more resources for the transmission of data to the second UE; and transmit the data to the second UE in the determined subset. The transceiver may be further configured to perform a channel sensing process to measure interference power in the one or more resources, and to determine whether the resources comprising the subset of the one or more resources are limited by any interference for the transmission of data. The transceiver may be further configured to: determine whether the listen-before-talk (LBT) process has succeeded or failed; and transmit a report including the success or failure of the LBT process to the second UE. The transceiver may be further configured to receive a message from a base station via the second UE including resources of the one or more resources within unlicensed frequency spectrum.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10A shows a first example of resource allocation for a sidelink unlicensed (SL-U) band UE according to some aspects of some of various exemplary embodiments of the present disclosure.

FIG. 10B shows a second example of resource allocation for an SL-U band UE according to some aspects of some of various exemplary embodiments of the present disclosure.

FIG. 10C shows a third example of resource allocation for an SL-U band UE according to some aspects of some of various exemplary embodiments of the present disclosure.

FIG. 10D shows a fourth example of resource allocation for an SL-U band UE according to some aspects of some of various exemplary embodiments of the present disclosure.

FIG. 11A shows an example illustrating allocating time and frequency resources to an SL-U UE according to some aspects of some of various exemplary embodiments of the present disclosure.

FIG. 11B shows another example illustrating allocating time and frequency resources to an SL-U UE according to some aspects of some of various exemplary embodiments of the present disclosure.

FIG. 12 shows example components of a UE for transmission and/or reception according to some aspects of some of various exemplary embodiments of the present disclosure.

FIG. 13 shows example components of a base station (BS) for transmission and/or reception according to some aspects of some of various exemplary embodiments of the present disclosure.

FIG. 14 shows a flow diagram illustrating an example resource allocation method performed by a BS according to some aspects of some of various exemplary embodiments of the present disclosure.

FIG. 15 shows a flow diagram illustrating another example resource allocation method performed by a BS according to some aspects of some of various exemplary embodiments of the present disclosure.

FIG. 16 shows a flow diagram illustrating an example resource allocation method performed by an SL-U UE according to some aspects of some of various exemplary embodiments of the present disclosure.

### DETAILED DESCRIPTION

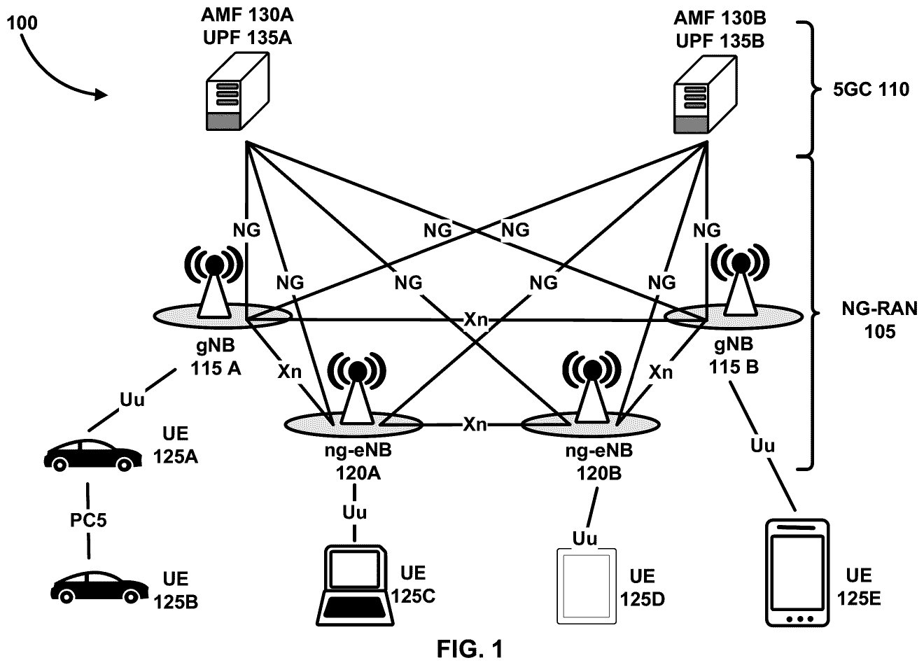

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

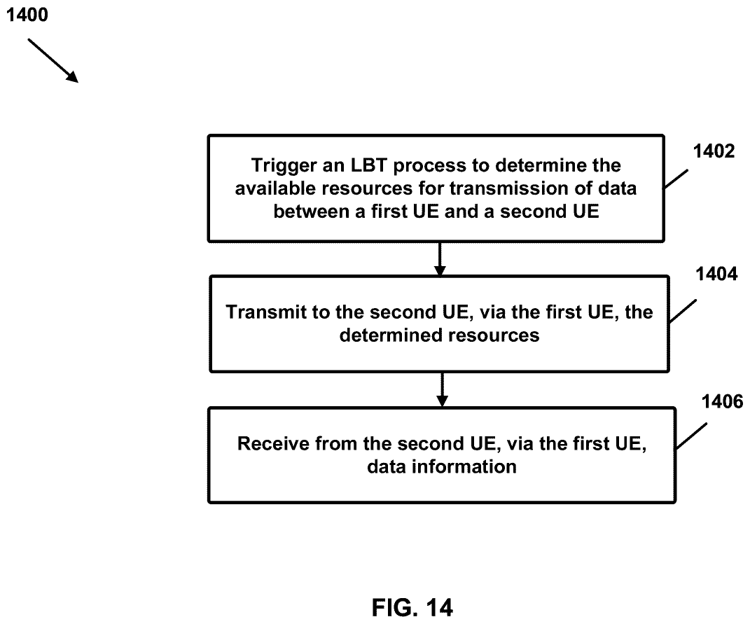

The system of mobile communications 100 may include a Radio Access Network (RAN) portion and a core network portion. The example shown in FIG. 1 illustrates a Next Generation RAN (NG-RAN) 105 and a 5G Core Network (5g-CN) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network FIG. 14 shows example of SL resource allocation process with pre-emption for aperiodic traffic according to some aspects of some of various exemplary embodiments of the present disclosure.

Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5G-CN 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that used the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably.

The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface.

The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE 125B). In the PC5 interface, the direction of communications between two UEs (e.g., from UE 125A to UE 125B or vice versa) may be referred to as sidelink.

Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may identify the sender of the data in NR sidelink communication. The Source Layer-2 ID may be 24 bits long and may be split in the MAC layer into two-bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver.

The Destination Layer-2 ID may identify the target of the data in NR sidelink communication. For NR sidelink communication, the Destination Layer-2 ID may be 24 bits long and may be split in the MAC layer into two-bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

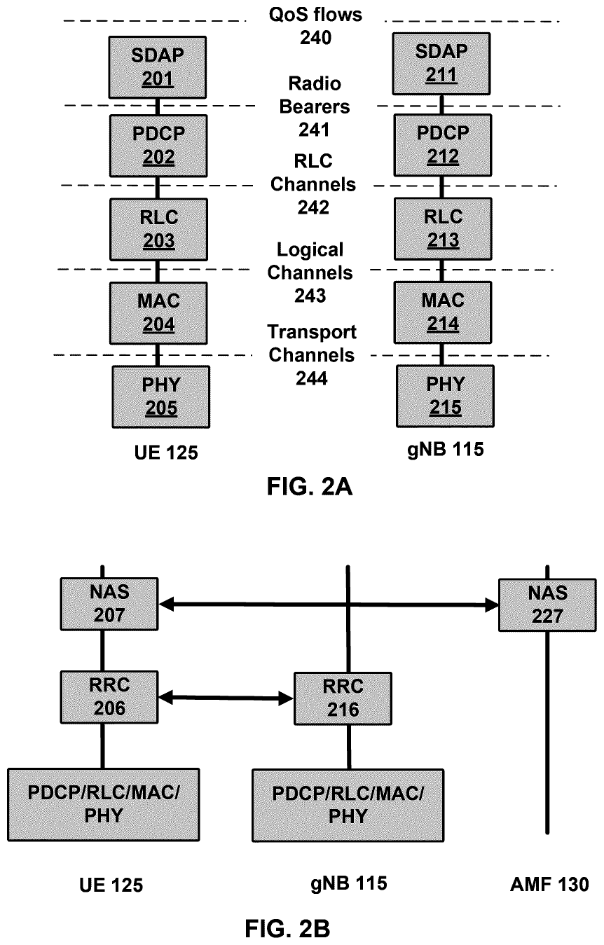

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

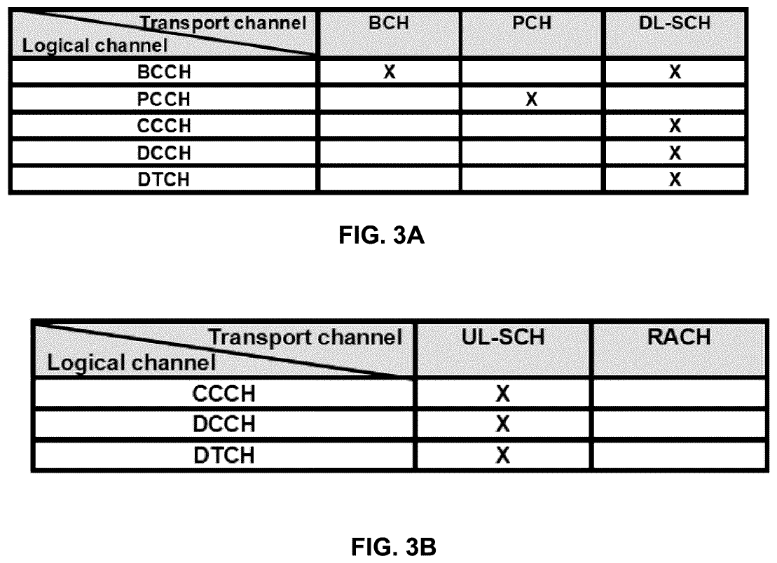

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is a channel for transmitting control information between UEs and network.

This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s).

Sidelink Broadcast Control Channel (SBCCH) is a sidelink channel for broadcasting sidelink system information from one UE to other UE(s). The downlink transport channel types include Broadcast Channel (BCH), Downlink Shared Channel (DL-SCH), and Paging Channel (PCH). BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving.

The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH. The uplink transport channel types include Uplink Shared Channel (UL-SCH) and Random-Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information, and collision risk.

In Uplink, the following connections between logical channels and transport channels may exist: CCCH may be mapped to UL-SCH; DCCH may be mapped to UL-SCH; and DTCH may be mapped to UL-SCH. The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

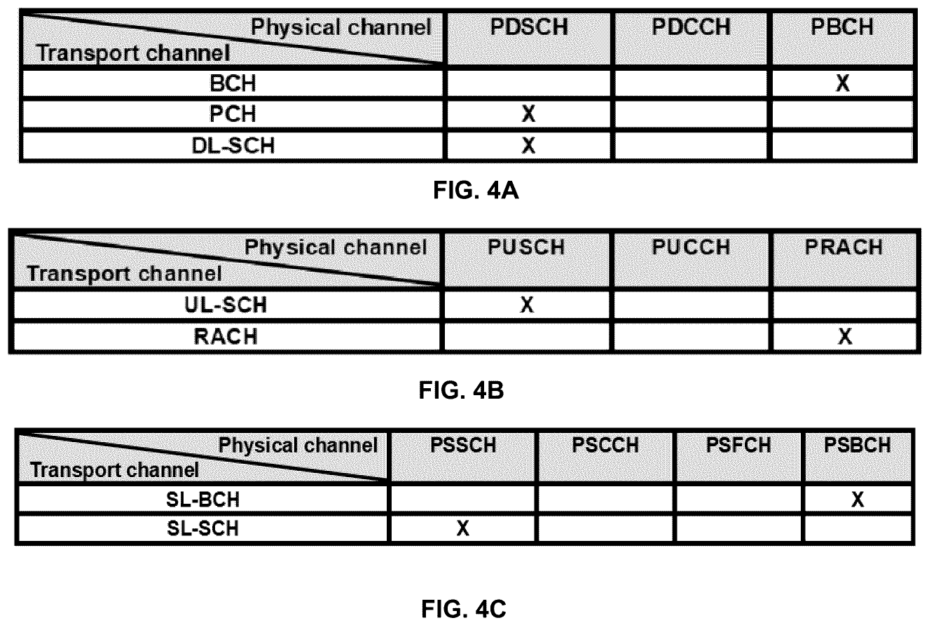

In the sidelink, the following connections between logical channels and transport channels may exist: SCCH may be mapped to SL-SCH; STCH may be mapped to SL-SCH; and SBCCH may be mapped to SL-BCH.0034] FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH, but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH, but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

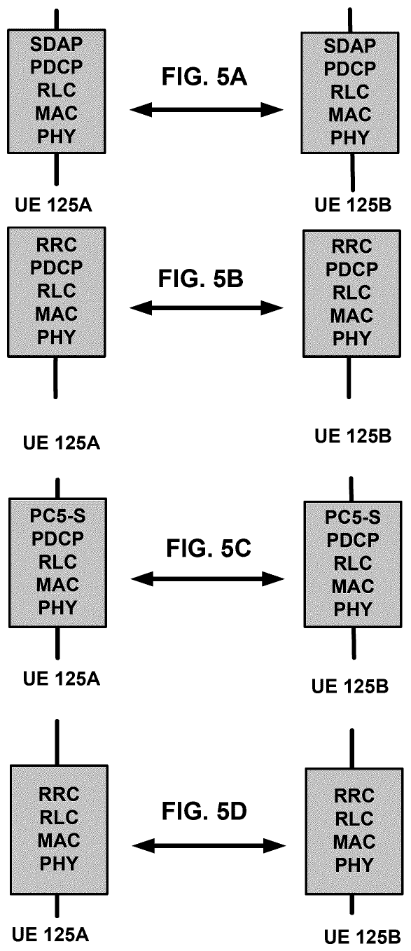

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively. The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

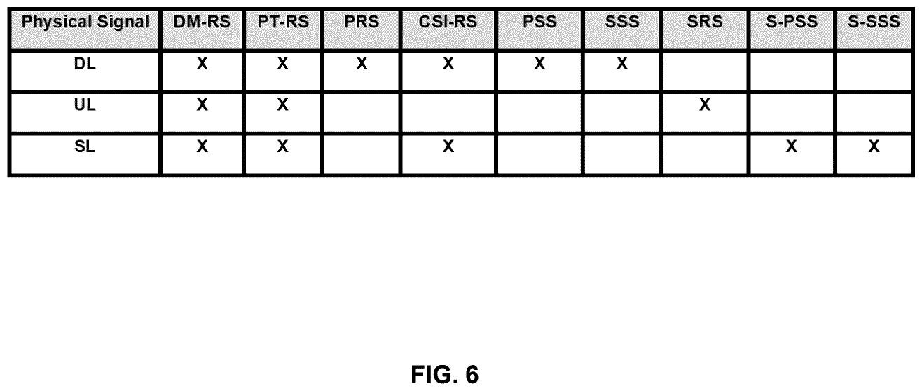

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses.

CSI-RS may be configured UE-specifically but multiple users may share the same CSI-RS resource. The UE may determine CSI reports and transmit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attachment or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

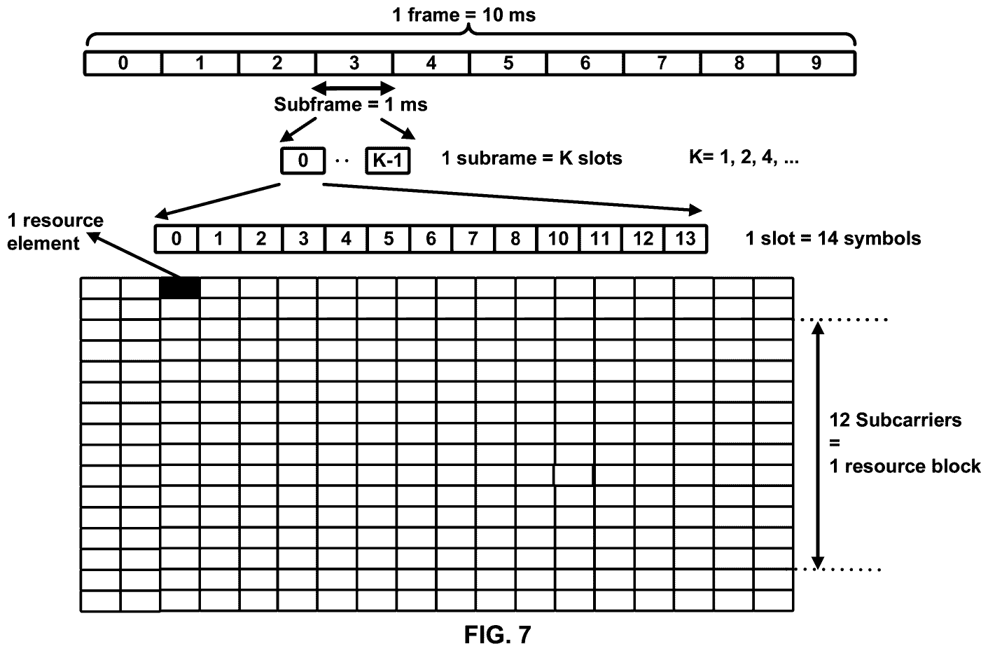

FIG. 7 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 7 shows a resource grid in time and frequency domain. Each element of the resource grid, comprising one symbol in time and one subcarrier in frequency, is referred to as a Resource Element (RE). A Resource Block RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

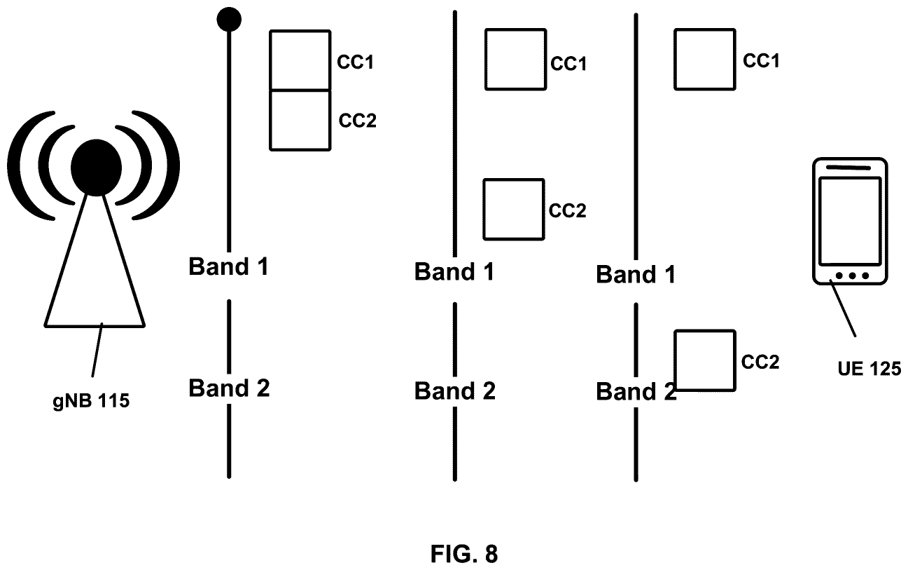

FIG. 8 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 8. A gNB and the UE may communicate using a serving cell. A serving cell may be associated with at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

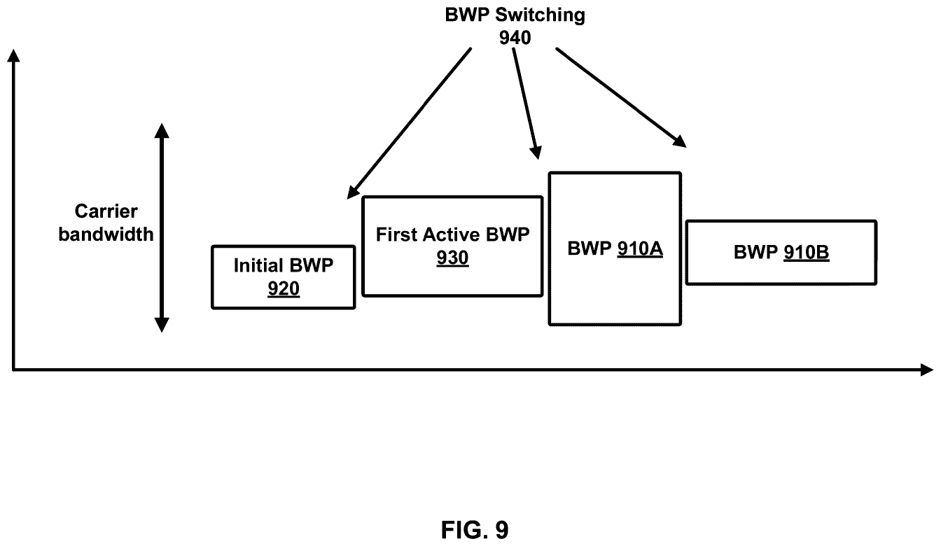

FIG. 9 shows example bandwidth part configuration and switching according to some aspects of some of various exemplary embodiments of the present disclosure. The UE may be configured with one or more Bandwidth Parts (BWPs) 910 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 920 determined from system information may be used. With Bandwidth Adaptation (BA), for example through BWP switching 940, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 920 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

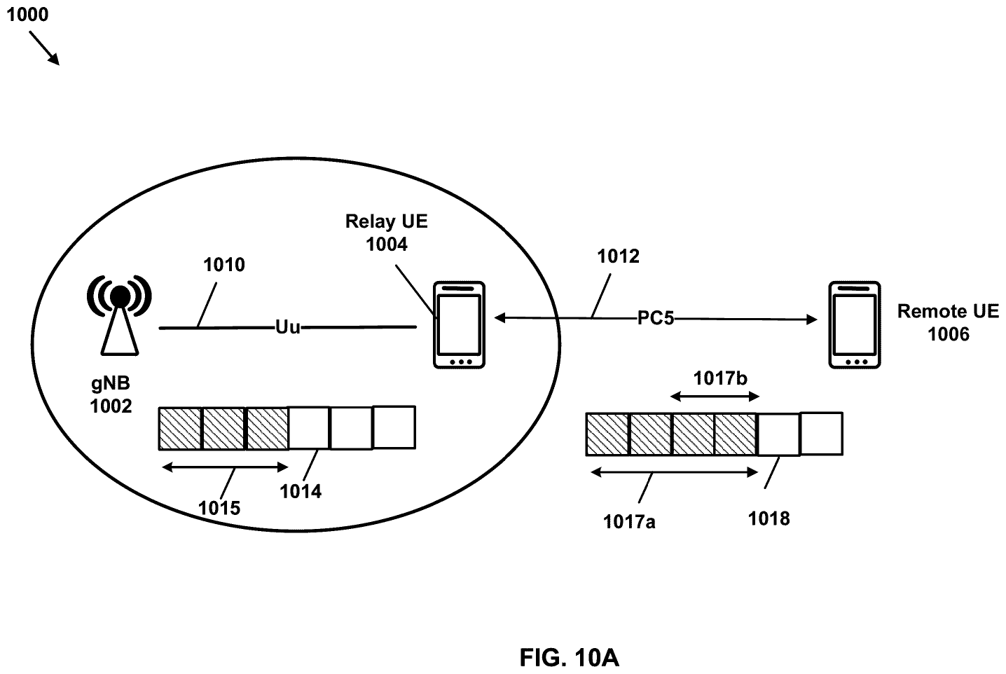

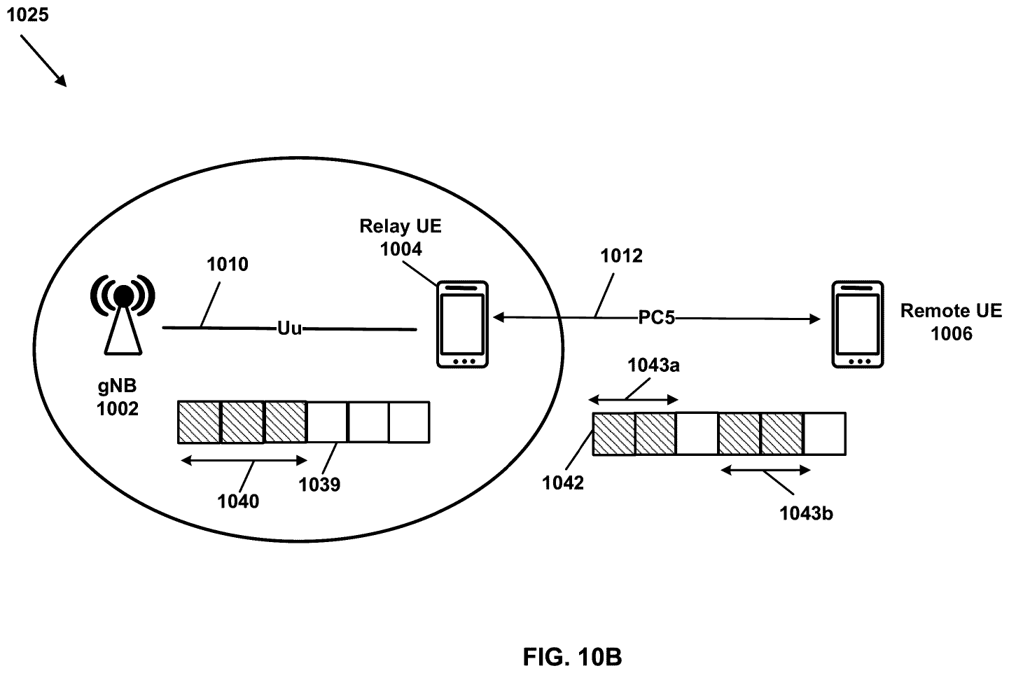

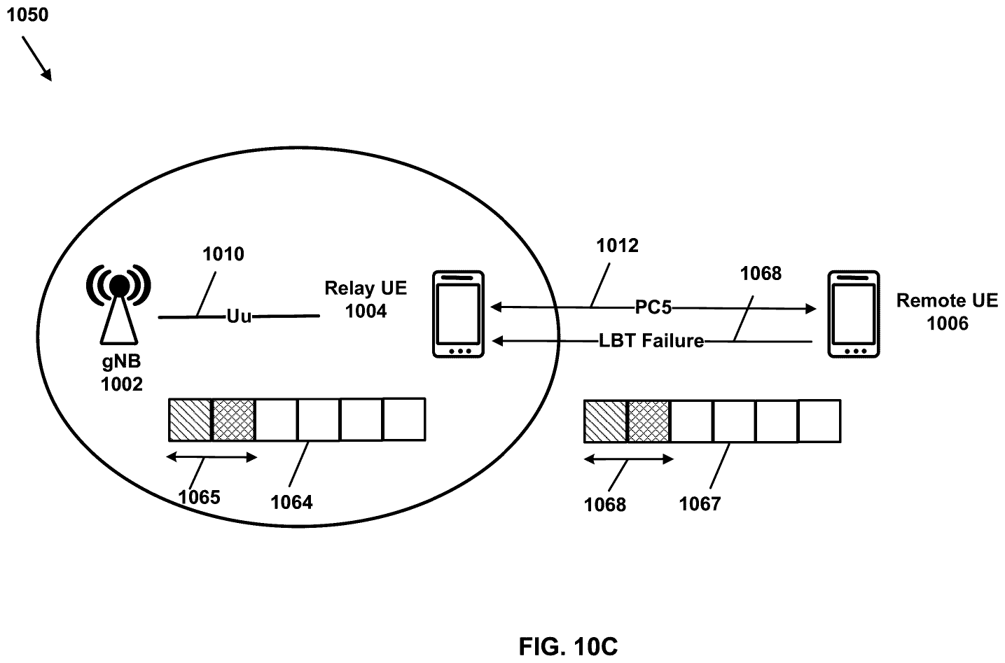

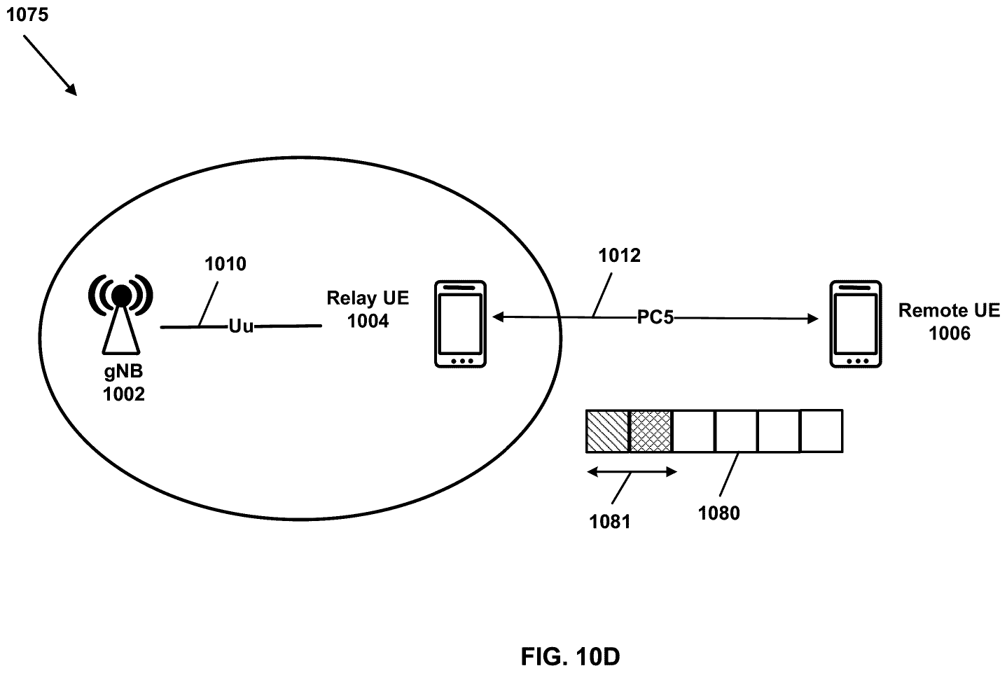

FIG. 10A shows a first example of sidelink communication scheme 1000, which uses resource allocation techniques according to some aspects of the present disclosure. The scheme 1000 may be employed by UEs 125A-B in a network such as networks 100 for sidelink communications. In particular, sidelink UEs may employ scheme 1000 for transmission and reception of Sidelink Control Information (SCI) and sidelink data over the forward/backward sidelink links 1012. For example, the relay UE 1004 may transmit SCI/sidelink data over the forward link to the remote UE 1006, and the remote UE 1006 may transmit SCI/sidelink data over the backward link to the relay UE 1004. In the scheme 1000, a relay UE 1004 within the coverage area of gNB 1002 and in communication with gNB 1002 over link 1010, may operate as a relay for the remote UE 1006. For instance, the UE 1004 may relay DL SCI/Data from the gNB 1002 to the UE 1006 over link 1012, and/or UL SCI/Data from UE 1006 to gNB 1002 over link 1012. gNB 1002 may be similar to gNB 115A-B. The relay UE 1004 may be similar to the relay UE 125A, and the remote UE 1006, 1034 may be similar to the remote UE 125B.

In the scheme 1000, the relay UE 1004 may communicate with the remote UE 1006 using a resource pool 1018. In some scenarios, the remote UE 1006 may reserve resources in the resource pool 1018 for transmission of data to the UE 1004. In the sidelink communication system 1025 (e.g., Unlicensed Spectrum (UL)), gNB 1002 may perform a listen-before-talk (LBT) process to determine the available time and frequency resources 1017a for the transmission of data at sidelink link 1012, and then transmits this subset of time and frequency resources, which passed LBT, to UE 1006 via UE 1004. Once UE 1006 receives the subset of available time and frequency resources from gNB 1002, UE 1004 may reserve time and frequency resources 1017a within resource pool 1018 for the transmission or reception of data. As shown, gNB 1002 determines the available resource 1017a, and transmits these resources via relay UE and 1004 to the remote UE 1006 in time and frequency resources 1015. In some examples, the UE may perform an LBT to verify the select resource 1017b, and then it may perform a channel sensing mechanism to reserve the resource 1017b for data transmission.

FIG. 10B shows a second example of sidelink communication scheme 1000, which uses resource allocation techniques according to some aspects of the present disclosure. The scheme 1025 may be employed by UEs 125A-B in a network such as networks 100 for sidelink communications. In particular, sidelink UEs may employ scheme 1025 for transmission and reception of Sidelink Control Information (SCI) and sidelink data over the forward/backward sidelink links 1012. For example, the relay UE 1004 may transmit SCI/sidelink data over the forward link to the remote UE 1006, and the remote UE 1006 may transmit SCI/sidelink data over the backward link to the relay UE 1004.

In the scheme 1000, a relay UE 1004 within the coverage area of gNB 1002 and in communication with gNB 1002 over link 1010, may operate as a relay for the remote UE 1006. For instance, the UE 1004 may relay DL SCI/Data from the gNB 1002 to the UE 1006 over link 1012, and/or UL SCI/Data from UE 1006 to gNB 1002 over link 1012. gNB 1002 may be similar to gNB 115A-B. The relay UE 1004 may be similar to the relay UE 125A, and the remote UE 1006, 1034 may be similar to the remote UE 125B. In the scheme 1025, the relay UE 1004 may communicate with the remote UE 1006 using a resource pool 1043. In some scenarios, the remote UE 1006 may reserve resources in the resource pool 1042 for transmission of data to the UE 1004.

In the sidelink communication system 1025 (e.g., Unlicensed Spectrum (UL)), gNB 1002 may perform a listen-before-talk (LBT) process to determine multiple time and frequency resources 1043a, 1043b for the transmission of data at sidelink link 1012, and then transmits these time and frequency resources, which passed LBT, to UE 1006 via UE 1004 and in resources 1040. Once UE 1006 receives the subset of available time and frequency resources from gNB 1002, UE 1004 may reserve time and frequency resources 1043a, and/or 1043b within resource pool 1042 for the transmission or reception of data.

FIG. 10C shows a third example of sidelink communication scheme 1050, which uses resource allocation techniques according to some aspects of the present disclosure. The scheme 1050 may be employed by UEs 125A-B in a network such as networks 100 for sidelink communications. In particular, sidelink UEs may employ scheme 1050 for transmission and reception of Sidelink Control Information (SCI) and sidelink data over the forward/backward sidelink links 1012. For example, the relay UE 1004 may transmit SCI/sidelink data over the forward link to the remote UE 1006, and the remote UE 1006 may transmit SCI/sidelink data over the backward link to the relay UE 1004. In the scheme 1000, a relay UE 1004 within the coverage area of gNB 1002 and in communication with gNB 1002 over link 1010, may operate as a relay for the remote UE 1006.

For instance, the UE 1004 may relay DL SCI/Data from the gNB 1002 to the UE 1006 over link 1012, and/or UL SCI/Data from UE 1006 to gNB 1002 over link 1012. gNB 1002 may be similar to gNB 115A-B. The relay UE 1004 may be similar to the relay UE 125A, and the remote UE 1006, 1034 may be similar to the remote UE 125B. In the scheme 1050, the relay UE 1004 may communicate with the remote UE 1006 using a resource pool 1067. In some scenarios, the remote UE 1006 may reserve resources 1068 in resource pool 1067 for transmission of data to the UE 1004.

In the sidelink communication system 1050 (e.g., Unlicensed Spectrum (UL)), gNB 1002 may perform a listen-before-talk (LBT) process to determine time and frequency resources 1068 for the transmission of data at sidelink link 1012, and then transmits these time and frequency resources, which passed LBT, to UE 1006 via UE 1004 and in resources 1065. In this example, UE 1006 may report the LBT failures 1068 to gNB 1002 via UCI. Accordingly, gNB 1002 considers the LBT failures in configuring the resources for the UE. For example, gNB may exclude those resources that failed LBT in scheduling UE 1006.

FIG. 10D shows a fourth example of sidelink communication scheme 1075, which uses resource allocation techniques according to some aspects of the present disclosure. The scheme 1075 may be employed by UEs 125A-B in a network such as networks 100 for sidelink communications. In particular, sidelink UEs may employ scheme 1075 for transmission and reception of Sidelink Control Information (SCI) and sidelink data over the forward/backward sidelink links 1012. For example, the relay UE 1004 may transmit SCI/sidelink data over the forward link to the remote UE 1006, and the remote UE 1006 may transmit SCI/sidelink data over the backward link to the relay UE 1004. In the scheme 1075, a relay UE 1004 within the coverage area of gNB 1002 and in communication with gNB 1002 over link 1010, may operate as a relay for the remote UE 1006. For instance, the UE 1004 may relay DL SCI/Data from the gNB 1002 to the UE 1006 over link 1012, and/or UL SCI/Data from UE 1006 to gNB 1002 over link 1012. gNB 1002 may be similar to gNB 115A-B. The relay UE 1004 may be similar to the relay UE 125A, and the remote UE 1006, 1034 may be similar to the remote UE 125B.

In the scheme 1075, the relay UE 1004 may communicate with the remote UE 1006 using a resource pool 1067. In some scenarios, the remote UE 1006 may reserve resources 1081 in resource pool 1080 for transmission of data to the UE 1004. In the sidelink communication system 1075 (e.g., Unlicensed Spectrum (UL)), UE 1006 may perform a listen-before-talk (LBT) process to determine time and frequency resources 1081 within the resource pool 1080 for the transmission of data at sidelink link 1012. In some examples, UE 1006 may perform a channel sensing mechanism to reserve resources in resources 1081 for the data transmission. For example, UE 1006 may measure signal power and interference in resources 1081, and excludes those resources that their interference level is higher than a threshold.

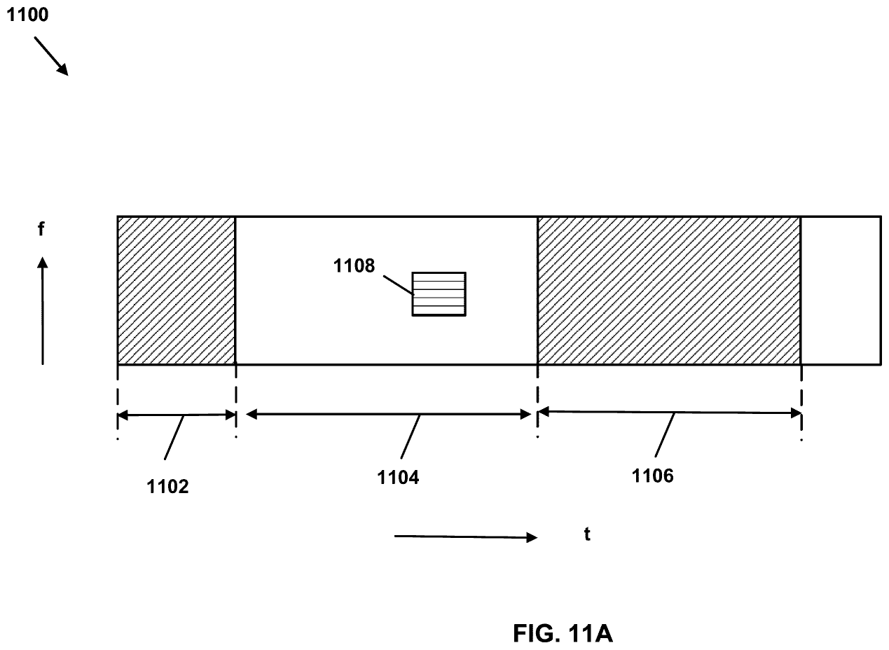

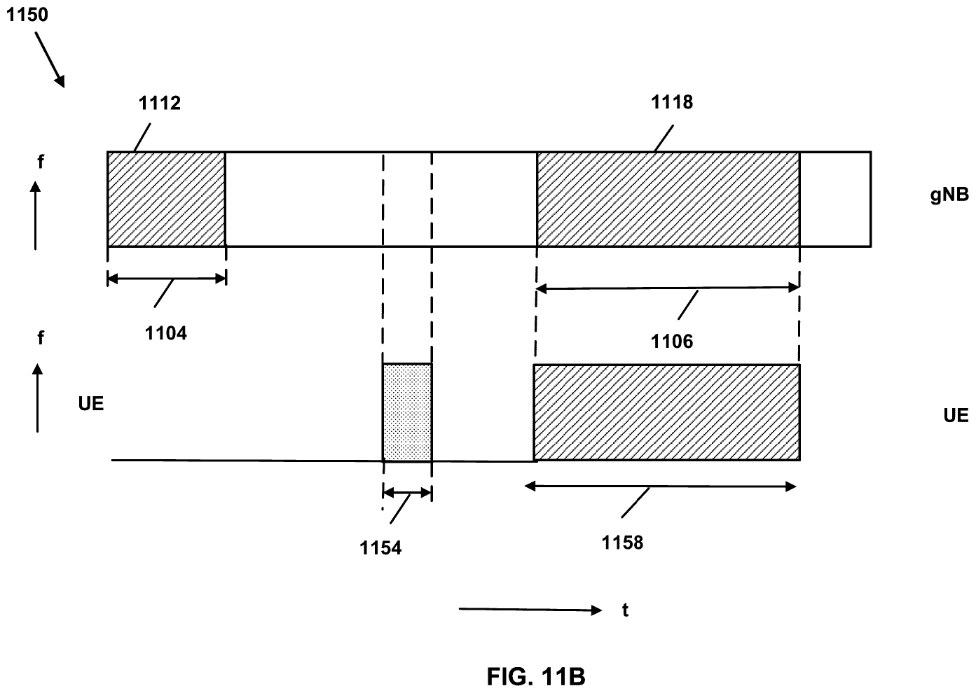

FIG. 11A shows an example illustrating time and frequency allocation for an SL-U UE according to some aspects of some of various exemplary embodiments of the present disclosure. The scheme 1100 may be employed by UEs 125A-B in a network such as networks 100 for sidelink communications. In particular, sidelink UEs may employ the scheme 1100 for SCI/SL data communication over the sidelink forward/backward links. In some respects, the scheme 1100 can be employed in conjunction with the scheme 1000, 1010, 1020, 1030, 1040 of FIG. 10A-D. In FIG. 1100, the x-axis represents time in some arbitrary units, and the y-axis represents frequency in some arbitrary units. The sidelink resource 1100 may be over a licensed band or a shared radio frequency band (e.g., in an unlicensed band). The resource 1100 may have the same frame structure 700 shown in FIG. 7. For instance, the resource 1100 may include a set of sidelink resource pool for a relay UE (e.g., relay UE 1004) with reference to FIG. 10A-D, arranged in a number of slots across time and a number of subbands in frequency similar to the resource 700 shown in FIG. 7.

As shown, a remote UE (e.g., UE 1006) or a gNB (e.g., gNB 1102) may perform an LBT process during time period 1102 to determine if resource 1106 is not occupied by any other device, and it is available for the data transmission or reception. Gap 1104 is provided to allow the LBT process to be completed before the start of resource 1106. Also, gap 1104 can provide extra time to perform another LBT in case the first LBT fails. When the LBT process succeeds for resource 1106, the UE may start transmitting in resource 1106. In some examples, if gNB performs the LBT process, it may schedule UE with resource 1106. In some examples, the UE may perform another LBT in resource 1106, to select part of 1106 for the transmission of data. In some examples, remote UE may perform a channel sensing mechanism during gap 1104 to measure interference in resource 1106, and reserve part of 1106 which are not limited for data transmission. In some examples, the remote UE may reserve the available resources for data transmission in resource 1106 via SCI 1108. In some other examples, the UE may report the LBT failures or success via SCI 1108 to the gNB.

FIG. 11B shows an example illustrating time and frequency allocation for an SL-U UE according to some aspects of some of various exemplary embodiments of the present disclosure. Scheme 1150 may be employed by UEs 125A-B in a network such as networks 100 for sidelink communications. In particular, sidelink UEs may employ the scheme 1150 for SCI/SL data communication over the sidelink forward/backward links. In some respects, the scheme 1150 can be employed in conjunction with the scheme 1000, 1010, 1020, 1030, 1040 of FIG. 10A-D. In FIG. 1100, the x-axis represents time in some arbitrary units, and the y-axis represents frequency in some arbitrary units. The sidelink resource 1150 may be over a licensed band or a shared radio frequency band (e.g., in an unlicensed band). Resource 1150 may have the same frame structure 700 shown in FIG. 7. For instance, the resource 1150 may include a set of sidelink resource pool for a relay UE (e.g., relay UE 1004) with reference to FIG. 10A-D, arranged in a number of slots across time and a number of subbands in frequency similar to the resource 700 shown in FIG. 7.

As shown, a gNB (e.g., gNB 1102) may perform an LBT process during time period 1102 to determine if resource 1106 is not occupied by any other device, and it is available for data transmission or reception. Gap 1104 is provided to allow the LBT process to be completed before the start of resource 1106. Also, gap 1104 can provide extra time to perform another LBT in case the first LBT fails. When the LBT process succeeds for resource 1106, the gNB may schedule the remote UE with resource 1106.

As shown, time period 1154 may include the resource selection period for the remote UE. In 1154, the UE may perform an LBT process to determine the available resource 1158 of resource 1118 for data transmission. Additionally, the remote UE may perform a channel sensing process during 1154 to reserve the part or the entire of resource 1158. In some examples, the remote UE may measure interference during 1154, and reserve 1158.

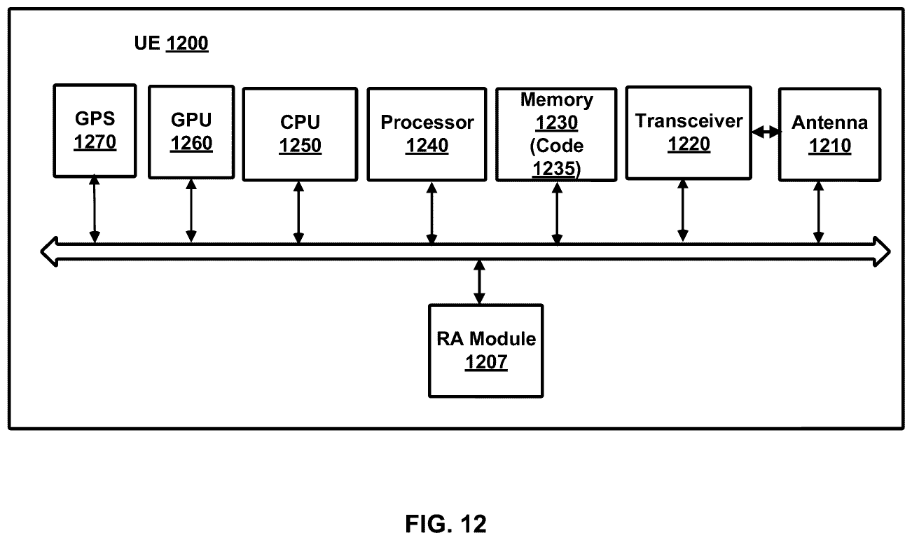

FIG. 12 shows example components of a remote or relay UE for transmission and/or reception according to some. All or a subset of blocks and functions in FIG. 12 may be in the UE 1200 and may be performed by the user equipment 1200. The Antenna 1210 may be used for transmission or reception of electromagnetic signals. The Antenna 1210 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1210 may enable a massive MIMO configuration with tens or hundreds of antenna elements. The Antenna 12410 may enable other multi-antenna techniques such as beamforming. In some examples and depending on the UE 1200 capabilities, the UE 1200 may support a single antenna only.

The transceiver 1220 may communicate bi-directionally, via the Antenna 1210, wireless links as described herein. For example, the transceiver 1220 may represent a wireless transceiver at the UE 1200 and may communicate bi-directionally with the wireless transceiver at the base station or vice versa. The transceiver 1220 may include a modem to modulate the packets and provide the modulated packets to the Antennas 1210 for transmission, and to demodulate packets received from the Antennas 1210.

The memory 1230 may include RAM and ROM. The memory 1230 may store computer-readable, computer-executable code 1235 including instructions that, when executed, cause the processor to perform various functions described herein. In some examples, the memory 1430 may contain, among other things, a Basic Input/output System (BIOS) which may control basic hardware or software operation such as the interaction with peripheral components or devices.

The processor 1240 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1240 may be configured to operate a memory using a memory controller. In other examples, a memory controller may be integrated into the processor 1240. The processor 1240 may be configured to execute computer-readable instructions stored in a memory (e.g., the memory 1230) to cause the UE 1200 to perform various functions.

The Central Processing Unit (CPU) 1250 may perform basic arithmetic, logic, controlling, and Input/output (I/O) operations specified by the computer instructions in the Memory 1230. The user equipment 1200 and may include additional peripheral components such as a graphics processing unit (GPU) 1260 and a Global Positioning System (GPS) 1270. The GPU 1260 is a specialized circuitry for rapid manipulation and altering of the Memory 1230 for accelerating the processing performance of the user equipment 1200. The GPS 1270 may be used for enabling location-based services or other services, for example based on geographical position of the user equipment 1200.

Resource Allocation (RA) module 1270, may perform resource allocation, resource reservation, scheduling, LBT process, and reporting LBT failure or success s as described in FIGS. 10A-D.

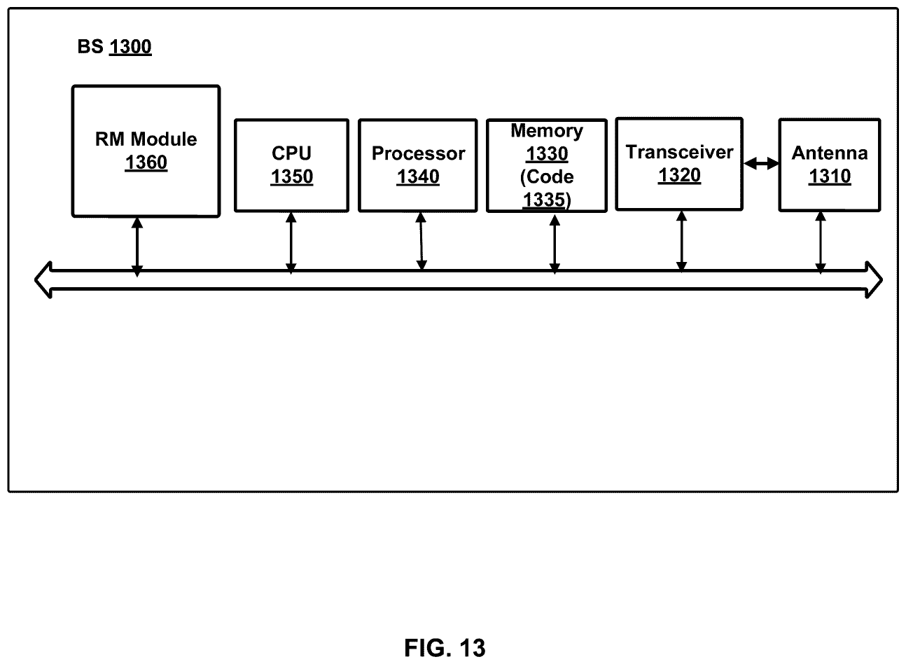

FIG. 13 shows example components of a BS or gNB (e.g., gNB 1002) for transmission and/or reception according to some aspects of some of various exemplary embodiments of the present disclosure. All or a subset of blocks and functions in FIG. 13 may be in the gNB 1300 and may be performed by the user equipment 1300. The Antenna 1310 may be used for transmission or reception of electromagnetic signals. The Antenna 1310 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1310 may enable a massive MIMO configuration with tens or hundreds of antenna elements. The Antenna 1310 may enable other multi-antenna techniques such as beamforming. In some examples and depending on the BS gNB00 capabilities, the gNB 1300 may support a single antenna only.

The transceiver 1320 may communicate bi-directionally, via the Antenna 1310, wireless links as described herein. For example, the transceiver 1320 may represent a wireless transceiver at the UE and may communicate bi-directionally with the wireless transceiver at the base station or vice versa. The transceiver 1320 may include a modem to modulate the packets and provide the modulated packets to the Antennas 1310 for transmission, and to demodulate packets received from the Antennas 1310.

The memory 1330 may include RAM and ROM. The memory 1330 may store computer-readable, computer-executable code 1335 including instructions that, when executed, cause the processor to perform various functions described herein. In some examples, the memory 1330 may contain, among other things, a Basic Input/output System (BIOS) which may control basic hardware or software operation such as the interaction with peripheral components or devices.

The processor 1340 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1340 may be configured to operate a memory using a memory controller. In other examples, a memory controller may be integrated into the processor 1340. The processor 1340 may be configured to execute computer-readable instructions stored in a memory (e.g., the memory 1330) to cause the gNB 1300 to perform various functions.

The Central Processing Unit (CPU) 1350 may perform basic arithmetic, logic, controlling, and Input/output (I/O) operations specified by the computer instructions in the Memory 1330. The Resource Allocation (RA) 1380, may perform resource allocation, resource reservation, scheduling, LBT process, and processing LBT failure or success s as described in FIGS. 10A-D.

FIG. 14 is a flow diagram illustrating an example method performed by a BS according to some aspects of some of various exemplary embodiments of the present disclosure. The steps of method 1400 can be executed by computing devices (e.g., a processor, processing circuit, and/or other components) of the UE. As illustrated, method 1400 may include additional steps before, after, and in between the enumerated steps.

At step 1402, a BS triggers, an LBT process to determine the available resources for transmission of data between a first UE and a second UE. The available resources include a number of time slots, and number of resource blocks. The first UE is a relay UE within the coverage area of the BS, and the second UE is a remote UE in communication with the first UE. In some examples, the resources may be within unlicensed frequency band.

At step 1404, the BS transmits to the second UE, via the first UE, the determined resources. In some examples the second UE may trigger an LBT process to determine a subset of resources in the in the available resources for the transmission of data between the first UE and the second UE. In some examples, the second UE may reserve the time and frequency resources in the subset for data transmission by SCI. Furthermore, the second UE may perform a channel sensing mechanism to reserve the resources within the subset for the data transmission. At step 1406, the BS receives data from the second UE via the first UE in the determined time and frequency resources.

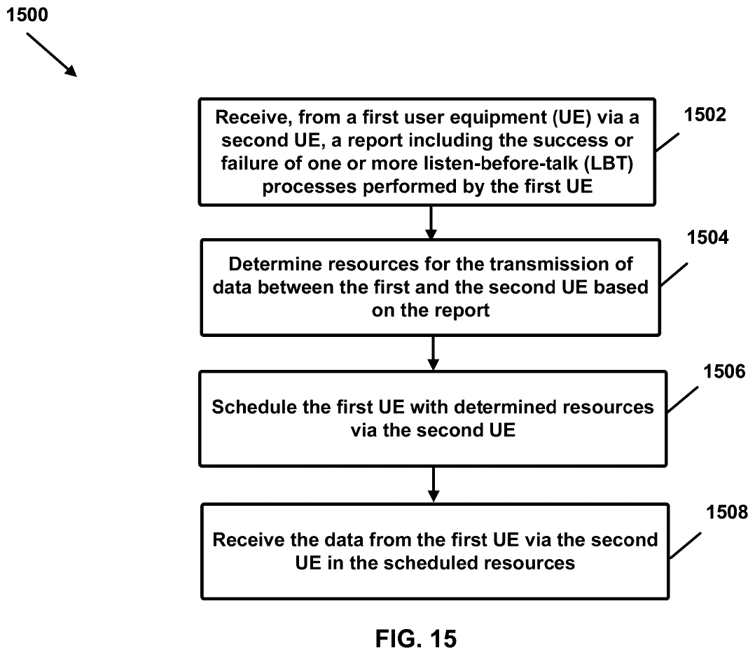

FIG. 15 is a flow diagram illustrating another resource allocation example method performed by a BS according to some aspects of some of various exemplary embodiments of the present disclosure. At step 1502, a BS receives, from a first UE via a second UE, a report including the success or failure of one or more listen-before-talk (LBT) processes performed by the first UE. In some examples, the first UE is the remote UE in communication with the second UE, and the second UE is the relay UE in the coverage range of the BS. In some examples, the first UE performs one or more LBT processes to inquire access to unlicensed spectrum.

At step 1504, the BS determines resources for the transmission of data between the first and the second UE based on the report. In some examples, the BS may run an LBT process to determine the resources. In another example, the BS may consider LBT failures in determining the resources. For example, the BS may exclude those resources that have failed process.

At step 1506, the BS schedules the first UE with the determined resources from the previous step. The BS transmits the resources to the first UE via the second UE. At step 1508, the BS receives data and control information form the first UE via the second UE.

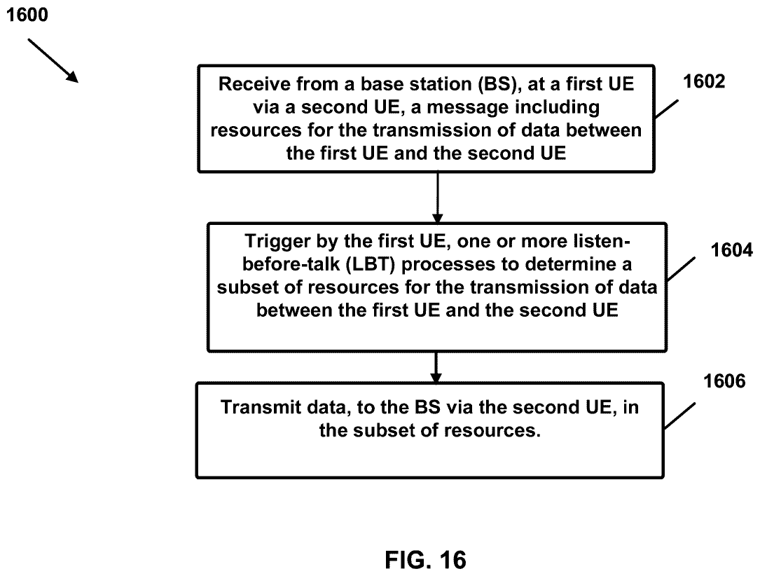

FIG. 16 is a flow diagram illustrating an example resource allocation method performed by a UE according to some aspects of some of various exemplary embodiments of the present disclosure.

At step 1602, a first UE receives from a base station (BS) via a second UE, a message including resources for the transmission of data between the first UE and the second UE. A first UE can be remote UE in communication with the first UE, and the second UE can be relay UE in the coverage area of the BS.

At step 1604, the first UE triggers one or more listen-before-talk (LBT) processes to determine a subset of resources for the transmission of data between the first UE and the second UE. The UE may perform an LBT to reduce the number of LBT failures. In some examples, the UE may report LBT failures and success to the BS.

At step 1606, the first UE transmits data to the BS via the second UE, in the subset of resources.

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor.

In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of data transmission performed by a first user equipment (UE), comprising the steps of:
receiving, by the first UE, one or more configuration parameters indicating a first set of time and frequency resources associated with partial sensing in sidelink communications;
monitoring for sidelink control information (SCI) based on the partial sensing and in one or more resources determined based on the one or more configuration parameters;
receiving, based on the monitoring, the SCI from a second UE; and
receiving, based on the SCI, sidelink data from the second UE.

2. The method of claim 1, wherein the first set of time and frequency resources includes one or more time slots in a same frequency subband.

3. The method of claim 1, wherein the first set of time and frequency resources includes one or more time slots in one or more frequency subbands.

4. The method of claim 1, wherein the one or more configuration parameters are transmitted via a dedicated channel defined for the transmission of the first set of time and frequency resources.

5. The method of claim 1, wherein the one or more configuration parameters are transmitted semi-statically via a Physical Sidelink Broadcast Channel (PSBCH).

6. The method of claim 1, wherein:
receiving the sidelink data is based on a second set of time and frequency resources; and
the second set of time and frequency resources is selected based on sensing the first set of time and frequency resources such that no collision occurs in the second set of time and frequency resources.

7. The method of claim 6, further comprising:
performing a pre-emption check before receiving traffic in the second set of time and frequency resources to determine if any other traffic collides with the resources in said second set.

8. The method of claim 1, wherein the sidelink data is a periodic traffic.

9. The method of claim 1, wherein the sidelink data is an aperiodic traffic.

10. The method of claim 1, wherein a base station (BS) configures the resources in the first set of time and frequency resources.

11. The method of claim 1, wherein:
the first user equipment (UE) is configured with discontinuous reception (DRX).

12. The method of claim 11, wherein the first set of time and frequency resources are within the DRX on duration.

13. The method of claim 1, wherein:
the first user equipment (UE) is configured with a wake up signal (WUS), wherein the WUS signal notifies to the first UE to wake up and monitor for sidelink control information (SCI) in the first set of time and frequency resources.

14. A user equipment (UE) comprising:
one or more processors; and
memory storing instructions, that when executed by the one or more processors, cause the UE to:
receive one or more configuration parameters indicating a first set of time and frequency resources associated with partial sensing in sidelink communications;
monitor for sidelink control information (SCI) based on the partial sensing and in one or more resources determined based on the one or more configuration parameters;
receive, based on the monitoring, the SCI from a second UE;
receive, based on the SCI, sidelink data from the second UE.

15. The user equipment (UE) of claim 14, wherein the first set of time and frequency resources includes one or more time slots in a same frequency subband.

16. The user equipment (UE) of claim 14, wherein the first set of time and frequency resources includes one or more time slots in one or more frequency subbands.

17. The user equipment (UE) of claim 14, wherein the one or more configuration parameters are transmitted via a dedicated channel defined for the transmission of the first set of time and frequency resources.

18. The user equipment (UE) of claim 14, wherein the one or more configuration parameters are transmitted semi-statically via a Physical Sidelink Broadcast Channel (PSBCH).

19. The user equipment (UE) of claim 14, wherein:
receiving the sidelink data is based on a second set of time and frequency resources; and
the second set of time and frequency resources is selected based on sensing the first set of time and frequency resources such that no collision occurs in the second set of time and frequency resources.

20.-26. (canceled)

27. A method of data transmission, performed by a base station, comprising the steps of:
transmitting, by the base station to a first user equipment (UE), one or more configuration parameters indicating a first set of time and frequency resources associated with partial sensing in sidelink communications; and
wherein:
sidelink control information (SCI) is monitored based on the partial sensing and in one or more resources determined based on the one or more configuration parameters;
the SCI is received from a second UE based on the monitoring; and
sidelink data is received from the second UE based on the SCI.

28.-53. (canceled)
